(19) United States
(12) Patent Application Publication
(10) Pub. No.: US 2026/0358058 A1
(43) Pub. Date: Nov. 12, 2026

(54) MANIFOLDS AND STEAM CRACKERS INCLUDING SAME

(71) Applicant: ExxonMobil Technology and Engineering Company, Spring, TX (US)

(72) Inventor: SAMUEL L. ALMEIDA, Spring, TX (US)

(21) Appl. No.: 19/669,599

(22) Filed: May 6, 2026

Related U.S. Application Data
(60) Provisional application No. 63/801,397, filed on May 7, 2025.

(51) Int. Cl. F27D 7/02; C10G 47/32; F27D 99/00

(52) U.S. Cl. CPC F27D 7/02; C10G 47/32; F27D 2007/023; F27D 2099/0086

(57) ABSTRACT

Manifolds and furnaces and processes for using same. The manifold can include a conduit having first and second ends. The first and second ends can be sealed via first and second end plates, respectively. The conduit and the first and second end plates can define a cavity therein. An inlet can be disposed on the conduit that can be configured to convey a fluid into the cavity. A plurality of outlets can be disposed on the conduit. Each outlet can be configured to convey a portion of the fluid out of the cavity. A plurality of service ports can be disposed on the conduit. Each service port can be configured to be sealed via a cover. A plurality of screens can be disposed within the cavity. Each screen can be inserted into and removed from the cavity via passage through an unsealed service port in the plurality of service ports.

### CROSS REFERENCE TO RELATED APPLICATIONS

This application claims priority to and the benefit of U.S. Provisional Application No. 63/801,397, entitled “Manifolds and Steam Crackers Including the Same,” filed May 7, 2025, the disclosure of which is incorporated herein by reference in its entirety.

### FIELD

Embodiments disclosed herein generally relate to manifolds, steam crackers including same, and processes for using same. More particularly, such embodiments relate to manifolds that include replaceable screens configured to reduce debris, e.g., coke, exiting outlet(s) of the manifolds that is present in a feed introduced into an inlet of the manifolds, steam crackers including same, and processes for using same.

### BACKGROUND

In steam crackers that produce alkenes, e.g., ethylene, a hydrocarbon is preheated in one or more convection section tubes to produce a pre-heated feed. Steam can be mixed with the pre-heated feed to produce a mixture that includes the hydrocarbon and steam. One convection section tube feeds multiple radiant tubes, which have a smaller cross-sectional area than the convection section tube, with the hydrocarbon and steam mixture. A distribution manifold is utilized to distribute the hydrocarbon and steam mixture into the multiple radiant tubes. The manifold includes replaceable screens that protect the individual radiant tubes from plugging with debris, e.g., coke, that can be produced within the larger convection section tube during preheating of the hydrocarbon feed.

The current manifolds include a blind flanged connected to an end of the manifold that can be removed to facilitate the removal and cleaning or replacement of the screens. For furnaces that position the manifolds linearly and adjacent to each other, the blind flanges are positioned on opposing sides of the manifolds. This provides a compact space-saving arrangement that enables removal of the screens through the ends of the flanges. This arrangement, however, limits the number of manifolds that can be positioned linearly and adjacent to each other to only two.

There is a need therefore, for improved manifolds that include screens therein that can be located more closely to one another to increase the number of manifolds for a given furnace having a fixed footprint. This disclosure satisfies this and other needs.

### SUMMARY

Manifolds, steam cracker furnaces including same, and processes for using same are provided. In some embodiments, the manifold can include a conduit that can have a first end and a second end. The first end of the conduit can be sealed via a first end plate. The second end of the conduit can be sealed via a second end plate. The conduit, the first end plate, and the second end plate can define a cavity therein. At least one inlet can be disposed on the conduit between the first end and the second end thereof that can be configured to convey a fluid into the cavity. A plurality of outlets can be disposed on the conduit between the first end and the second end thereof. Each outlet can be configured to convey a portion of the fluid out of the cavity. A plurality of service ports can be disposed on the conduit between the first end and the second end thereof. Each service port can be configured to be sealed via a cover. A plurality of screens can be disposed within the cavity. Each screen in the plurality of screens can be configured to be inserted into and removed from the cavity via passage through an unsealed service port in the plurality of service ports. Each screen can define a plurality of openings between a first end and a second end thereof.

In some embodiments, a steam cracker furnace can include a radiant firebox that can include a plurality of radiant tubes disposed therein. The steam cracker furnace can also include at least one manifold that can have a first end and a second end. The first end of the conduit can be sealed via a first end plate. The second of the conduit can be sealed via a second end plate. The conduit, the first end plate, and the second end plate can define a cavity therein. At least one inlet can be disposed on the conduit between the first end and the second end thereof. The inlet can be configured to convey a hydrocarbon and steam mixture into the cavity. A plurality of outlets can be disposed on the conduit between the first end and the second end thereof. Each outlet in the plurality of outlets can be configured to convey a portion of the hydrocarbon and steam mixture out of the cavity and into a corresponding radiant tube in the plurality of radiant tubes. A plurality of service ports can be disposed on the conduit between the first end and the second end thereof. Each service port can be configured to be sealed via a cover. A plurality of screens can be disposed within the cavity. Each screen in the plurality of screens can be configured to be inserted into and removed from the cavity via passage through an unsealed service port in the plurality of service ports. Each screen can define a plurality of openings between a first end and a second end thereof.

A steam cracking process using the steam cracker furnace can include combusting a fuel within the radiant firebox to produce heat and a flue gas. A hydrocarbon and steam mixture can be introduced into the at least one inlet disposed on the conduit. A portion of the hydrocarbon and steam mixture can be conveyed into each outlet disposed on the conduit and into the corresponding radiant tube located within the radiant firebox to produce a steam cracker effluent.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a cross-sectional side elevation view of a manifold that includes a plurality of screens located within a cavity of the manifold, according to one or more embodiments described.

FIG. 2 depicts a cross-sectional end view of the manifold shown in FIG. 1 taken along line 2-2.

FIG. 3 depicts a side view of one of the screens shown in FIG. 1.

FIG. 4 depicts a front view of the screen shown in FIG. 3.

FIG. 5 depicts a plan view of a plurality of the manifolds shown in FIG. 1 arranged in a compact configuration, according to one or more embodiments described.

FIG. 6 depicts a partial cross-sectional perspective view of a portion of an illustrative steam cracker configured to provide a hydrocarbon and steam mixture to a plurality of radiant tubes disposed within the steam cracker via a plurality of the manifolds shown in FIGS. 1 and 2, according to one or more embodiments described.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

The indefinite article “a” or “an”, as used herein, means “at least one” unless specified to the contrary or the context clearly indicates otherwise. Thus, embodiments using “a separator” include embodiments where one or two or more separators are used, unless specified to the contrary or the context clearly indicates that only one separator is used. Likewise, embodiments using “a separation stage” include embodiments where one or two or more separation stages are used, unless specified to the contrary.

In this disclosure, a process is described as comprising at least one “step.” It should be understood that each step is an action or operation that may be carried out once or multiple times in the process, in a continuous or discontinuous fashion. Unless specified to the contrary or the context clearly indicates otherwise, multiple steps in a process may be conducted sequentially in the order as they are listed, with or without overlapping with one or more other steps, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Certain embodiments and features are described herein using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. All numerical values are “about” or “approximately” the indicated value, and take into account experimental error and variations that would be expected by a person having ordinary skill in the art. Efforts have been made to ensure the accuracy of the data in the examples. However, it should be understood that any measured data inherently contains a certain level of error due to the limitation of the technique and/or equipment used for acquiring the measurement.

In this disclosure, “A, B, … or a combination thereof” means “A, B, … or any combination of any two or more of A, B, …” and “A, B, …, or a mixture thereof” means “A, B, …, or any mixture of any two or more of A, B, …”

Various specific embodiments, versions, and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

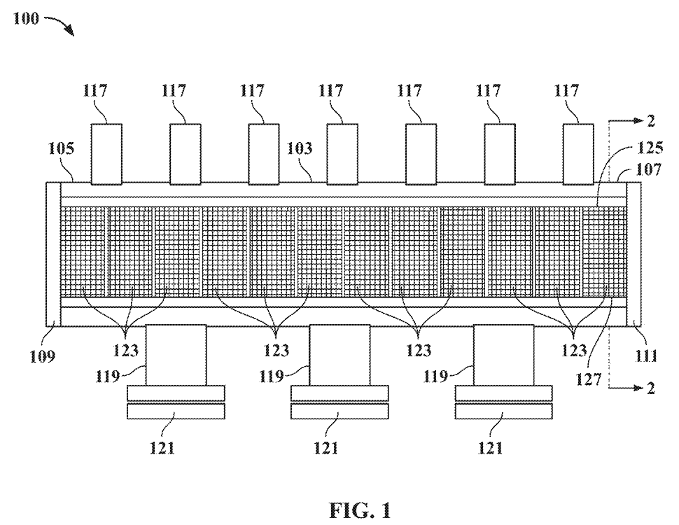

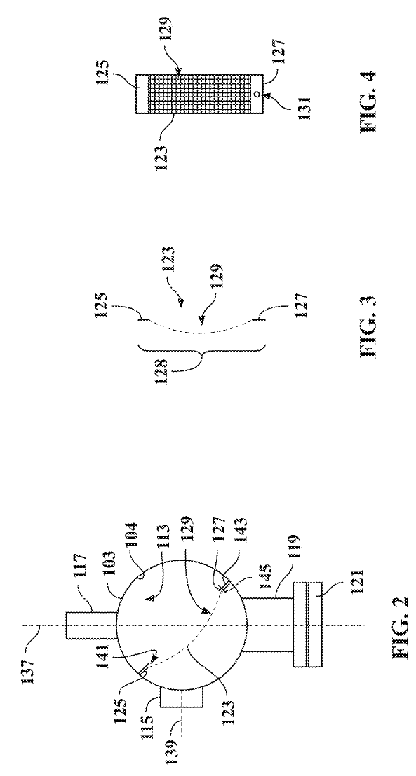

FIG. 1 depicts a cross-sectional side elevation view of an illustrative manifold 100 that includes a plurality of screens 123 located within a cavity 113 of the manifold 100, according to one or more embodiments. FIG. 2 depicts a cross-sectional end view of the manifold shown in FIG. 1 taken along line 2-2. Referring to FIGS. 1 and 2, the manifold 100 can include a conduit 103 that has a first end 105 and a second end 107. The first end 105 of the conduit 103 can be sealed via a first plate 109. The second end 107 of the conduit 103 can be sealed via a second plate 111. The conduit 103, the first end plate 109, and the second end plate 111 can define the cavity 113 within the manifold 100.

The conduit 103 can also include at least one inlet 115 disposed thereon between the first end 105 and the second end 107 thereof. The inlet 115 can be configured to convey a fluid, e.g., a hydrocarbon and steam mixture, into the cavity 113. The conduit 103 can also include at least one outlet 117, e.g., a plurality of outlets 117 (seven are shown), disposed thereon between the first end 105 and the second end 107 thereof. Each outlet 117 can be configured to convey a portion of the fluid out of the cavity 115. The conduit 103 can also include a plurality of service ports 119 (three are shown) disposed thereon between the first end 105 and the second end 107 of the conduit 103. Each service port 119 can be configured to be sealed via a cover 121. In some embodiments, the conduit 103, the first end plate 105, the second end plate 107, the inlet 115, the plurality of outlets 117, the service ports 119, the covers 121, and the plurality of screens 123 can be formed from metal, e.g., carbon steel or stainless steel.

Each screen 123 disposed within the cavity 113 can be configured to be inserted into and removed from the cavity 113 via passage through an unsealed service port 119. As such, the number of screens 123 (twelve are shown) disposed within the cavity 113 can depend, at least in part, on the length of the conduit 103 and the cross-sectional area of the service ports 119. Each screen 123 can have a first end 125 and a second end 127 and can define a plurality of openings 129 between the first end 125 and the second end 127 thereof. As shown in FIG. 1, the plurality of screens 123 can include a first end screen 123 that can abut the first end plate 109, a second end screen 123 that can abut the second end plate 111, and a plurality of intermediate screens 123 that serially abut one another such that the first end of the plurality of intermediate screens abuts the first end screen and a second end of the plurality of intermediate screens abuts the second end screen. In some embodiments, each screen 123 can have the same width. In other embodiments, one or more of the screens 123 can have a different width with respect to one or more other screens 123. In other words, the width of the screens 123 can be the same or different with respect to one another.

In some embodiments, the first end plate 109 and the second end plate 111 can be welded to the first end 105 and the second end 107 of the conduit 103, respectively. In other embodiments, the first end plate 109 and the second end plate 111 can be secured to the first end 105 and the second end 107 of the conduit 103, respectively, via a plurality of fasteners, e.g., bolts, bolts and nuts, rivets, or a combination thereof. For example, in some embodiments, the first end 105 and the second end 107 of the conduit 103 can include a flange radially extending from the conduit 103 that can define a plurality of bores and the first end plate 105 and the second end plate 107 can define a plurality of bores that correspond to the plurality of bores defined by the flanges of the first and second end plates 109, 111. In one such embodiment, an inner surface of the plurality of bores defined by the flanges can include a smooth inner surface and an inner surface of the plurality of bores defined by the first and second end plates 109, 111 can include a threaded inner surface or vice versa and a plurality of bolts can be used to secure the first and second end plates 109, 111 to the first and second ends 105, 107 of the conduit 103, respectively, by passing the bolt through the smooth bore and threadingly engaging the bolts with the threaded inner surface. In another such embodiment, the inner surface of the plurality of bores defined by the flanges and the inner surface of the plurality of bores defined by the first and second end plates 109, 111 can be smooth and a plurality of bolts and nuts or rivets can be used to secure the first and second end plates 109, 111 to the first and second ends 105, 107 of the conduit 103. In still other embodiments, the first and second ends 105, 107 of the conduit 103 can include a threaded outer surface or inner surface and the first and second end plates 109, 111 can include a threaded outer perimeter or can be end caps that include a threaded inner surface configured to threadingly engage with the threaded surfaces at the first and second ends 105, 107 of the conduit 103.

As shown, in some embodiments, the conduit 103 can include a single inlet 115 disposed thereon. In some embodiments, the single inlet 115 can be centrally located between the first and second ends 105, 107 of the conduit 103. In other embodiments, however, the single inlet 115 can be located closer to the first end 105 than the second end 107 or vice versa. In other embodiments, the conduit 103 can include two, three, or more inlets 115 disposed thereon. The number of inlets 115 and the number of outlets 117 disposed on the conduit 103 can be different from one another. In some embodiments, the number of inlets 115 disposed on the conduit 103 can be less than the number of outlets 117 disposed on the conduit 117. In other embodiments, the number of inlets 115 disposed on the conduit 103 can be greater than the number of outlets 117 disposed on the conduit 103. The inlet(s) 115 can be configured to be in fluid communication with a fluid supply conduit, e.g., a hydrocarbon and steam line, that can introduce the fluid into the inlet(s) 115.

The inlet(s) 115 and the plurality of outlets 117 are described as being configured to introduce a fluid into the cavity 113 and to convey a portion of the fluid out of the cavity 113, respectively. It should be understood, however, that the function or role of the inlet(s) 115 and the plurality of outlets 117 can be reversed. More particularly, in other embodiments, the plurality of outlets 117 can be configured to convey the fluid into the cavity 113 and the inlet 115 can be configured to convey all of the fluid out of the cavity 113, or when two or more inlets 115 are disposed on the conduit 103, each of the two or more outlets 114 can be configured to convey a portion of the fluid out of the cavity 113.

In some embodiments, the plurality of outlets 117 can be aligned with one another along a length of the conduit 103. In other embodiments, one or more of the plurality of outlets 117 can be unaligned with one or more of the plurality of outlets 117 along the length of the conduit 103. In some embodiments, the plurality of outlets 117 can be equally spaced apart from one another along the length of the conduit 103. In other embodiments, the plurality of outlets 117 can be unequally spaced apart from one another along the length of the conduit 103. In some embodiments, the plurality of access ports 119 can be aligned with one another along the length of the conduit 103. In other embodiments, one or more of the plurality of access ports 119 can be unaligned with one or more of the plurality of access ports 119 along the length of the conduit 103. In some embodiments, the plurality of access ports 119 can be equally spaced apart from one another along the length of the conduit 103. In other embodiments, the plurality of access ports 119 can be unequally spaced apart from one another along the length of the conduit 103.

In some embodiments, the plurality of outlets 117 and the plurality of access ports 119 can be disposed on opposite sides of the conduit 103 with respect to one another, as best shown in FIG. 2. For example, in some embodiments, the plurality of outlets 117 and the plurality of access ports 119 can be aligned along a central longitudinal axis 137. In other embodiments, however, the plurality of outlets 117 can be disposed closer to the plurality of access ports 119, e.g., to the left or right of axis 137, such that the plurality of outlets 117 and the plurality of access ports 119 are unaligned along the axis 137.

In some embodiments, a central longitudinal axis 139 of the inlet 115 can be oriented at an angle in a range from 80 degrees, 83 degrees, 85 degrees or 87 degrees to 93 degrees, 95 degrees, 97 degrees, or 100 degrees, e.g., 90 degrees, with respect to the central longitudinal access 137 of the plurality of access ports 119 and the plurality of outlets 117. In other embodiments, the central longitudinal axis 139 of the inlet 115 can be oriented at an angle less than 80 degrees or greater than 100 degrees with respect to the central longitudinal axis 137 of the plurality of access ports 119 and/or the plurality of outlets 117.

In some embodiments, the plurality of covers 121 can independently be a plate flange or a plug flange that can be secured to a corresponding service port 119 via a plurality of fasteners. Suitable fasteners can be or can include, but are not limited to, bolts, bolts and nuts, or a combination thereof. In other embodiments, one or more of the covers 121 can be secured to a corresponding service port 119 via threads. For example, an inner surface of a service port 119 can include threads and an outer perimeter of a corresponding cover 121 can include threads that can threadingly engage with the threads on the inner surface of the service port 119. In another example, an outer surface a service port 119 can include threads and a corresponding cover 121 can be an end cap that includes threads on an inner surface thereof configured to threadingly engage with the threads on the outer surface or the service port 119.

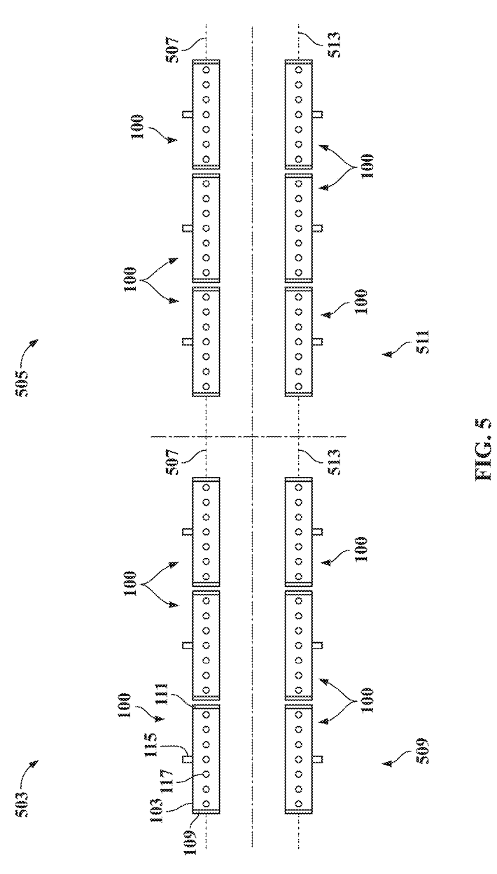

FIG. 3 depicts a side view of one of the screens 123 shown in FIG. 1. FIG. 4 depicts a front view of the screen 123 shown in FIG. 3. As shown in FIG. 3, in some embodiments, the screens 123 can have a curved 128 surface between the first end 125 and the second end 127 thereof. As shown, the curved surfaced 128 can curve toward the inlet 115 when installed within the cavity 113. In other embodiments, the curved surface 128 can curve away from the inlet 115 when installed within the cavity 113.

As shown, in some embodiments, each screen 123 can have the same or substantially the same width. In other embodiments, however, each screen 123 can independently have a width that can be the same or different with respect to any one or more of the screens 123. In other words, one or more screens 123 can have a first width, one or more screens 123 can have a second width, where the first width and the second width are different from one another. It should be understood that any number of screens 123 can have a first width, a second width, and so on where the first width, the second width, and so on can be different from one another.

In some embodiments, the screens 123 can be formed from a metal plate that defines the plurality of openings 129 therethrough. In such embodiments, the plurality of openings 129 can have any desired cross-sectional shape. In some embodiments, the openings 129 can be elliptical, e.g., circular, triangular, rectangular, e.g., a square, pentagonal, hexagonal, or any other desired shape. In some embodiments, a first number or quantity of the openings 129 in a given screen 123 can have a first cross-sectional shape and a second number or quantity of openings 129 in the screen can have a second cross-sectional shape. In other embodiments, a first number or quantity of the openings in a given screen 123 can have a first cross-sectional shape, a second number or quantity of openings 129 in the screen can have a second cross-sectional shape, a third number or quantity of openings 129 in the screen can have a third cross-sectional shape, and so on. In some embodiments, the openings 129 in a given screen 123 can be formed via drilling, milling, a punch, or any other suitable process. In other embodiments, the openings 129 in a given screen 123 can be formed during manufacture of the screen. For example, the screen 123 can be made via casting and the openings 129 can be formed via the mold during the casting process. In another example, the screen 123 can be an expanded metal mesh that can be made by cutting and stretching a metal sheet to create diamond-shaped openings.

In some embodiments, the screens 123 can be in the form of a wire mesh that can define the plurality of openings 129 therethrough. Any type of weave can be used to produce a screen 123 composed of a wire mesh. In some embodiments, the wires that make up the wire mesh for a given screen 123 can be weaved together to form the screen 123. Illustrative types of weaves can include plain weave wire mesh, plain Dutch weave wire mesh, twilled weave wire mesh, twilled Dutch weave wire mesh, crimped woven wire mesh, welded wire mesh, crimped knitted wire mesh, hexagonal wire mesh, lock crimp metal mesh, or any other suitable weave.

In some embodiments, the openings 129 in the screens 123 can have an average cross-sectional length in a range from 3 mm, 4 mm, 5 mm, 6 mm, or 7 mm to 8 mm, 9 mm, 10 mm, 11 mm, 12 mm, 13 mm, 14 mm, or 15 mm. In some embodiments, the average cross-sectional length of the openings 129 in a given screen 123 can be the same or different with respect to one another. In some embodiments, a first number or quantity of openings 129 in a given screen can have a first average cross-sectional length and a second number or quantity of openings 129 in the screen can have a second average cross-sectional length that is different than the first cross-sectional length. Similarly, the openings 129 in a first screen 123 can be the same or different with respect to the openings 129 in a second screen 123. Additionally, the screens 123 can be of the same type, e.g., all formed from a metal plate or all formed by weaving wires together, or of different types, e.g., some screens 123 can be formed from a metal plate and some screens can be formed by weaving wires together.

In some embodiments, the first end 125 of each screen 123 can be located within a slot 141 formed on an inner surface 104 of the conduit 103 between the first end 105 and the second end 107 thereof and the second end 127 of each screen 123 can be secured to a structural member 143 that is secured to the inner surface 104 of the conduit 103. In some embodiments, the slot 141 can be formed by securing, e.g., welding, a u-channel, a c-channel, or other elongated member to the inner surface 104 of the conduit 103 so that the first end 125 of each screen 123 can be positioned within the channel. In other embodiments, the slot 141 can be formed by securing two substantially parallel flat bars or other elongated members to the inner surface 104 of the conduit 103. In still other embodiments, the slot 141 can be formed into the inner surface 104, e.g., via cutting or grinding, such that the inner surface 104 of the conduit 103 defines the slot 141.

In some embodiments, the structural member 143 can be a flat bar or other elongated member that can be secured to the inner surface 104 of the conduit 103. In such embodiment, the second end 127 of each screen 123 can be secured to the structural member 143 via a fastener 145. For example, in some embodiments, the second end 127 of the screen 123 can define an aperture 131 therethrough and the fastener 145 can be disposed through the aperture 131 and a corresponding aperture (not visible) defined by the structural member 143. Illustrative fasteners can be or can include, but are not limited to, a pin, a screw, a bolt and a nut, a wire, or a combination thereof. In some embodiments, the fastener 145 can be a cotter pin.

Although not shown, in some embodiments, the second end 127 of the screen 123 can be located within a second slot formed on the inner surface 104 of the conduit 103 between the first end 105 and the second end 107 thereof, similar to the first end 125 of the screen 123. In such embodiment, the screen 123 can exhibit sufficient flexibility to permit the screen to bend a sufficient amount to allow the first end 125 or the second end 127 of the screen 123 to be positioned within the slot 141 or the second slot after the opposing end has been positioned within the corresponding slot.

FIG. 5 depicts a plan view of a plurality of the manifolds 100 shown in FIG. 1 arranged in a compact configuration, according to one or more embodiments. As shown in FIG. 5, two sets of manifolds 503, 505 that each include a first, a second, and a third manifold 100 can be serially aligned along a first longitudinal axis 507 and two sets of manifolds 509, 511 that each include a first, a second, and a third manifold 100 can be serially aligned along a second longitudinal axis 513. As also shown, the three manifolds 100 in each set can be positioned close to one another to provide a compact configuration for each set of 503, 505, 509, and 511. Such a compact arrangement can be used to increase the number of radiant tubes within a steam cracker that has a fixed footprint as compared to existing manifolds because the screens 123 can be inserted into and removed from the cavity 113 via the service ports 119 (see FIGS. 1 and 2) instead of having to remove one of the end plates 109, 111 to facilitate the insertion and removal of the screens 123 from the cavity 113. It should be understood that any number of the manifolds 100 can be serially aligned with respect to one another, e.g., three, four, five, six, or more. The number of manifolds 100 serially aligned with one another in a given set of serially aligned manifolds 100 can depend, at least in part, on the number of radiant tubes each manifold 100 supplies the hydrocarbon and steam mixture to and the size of the steam cracker furnace.

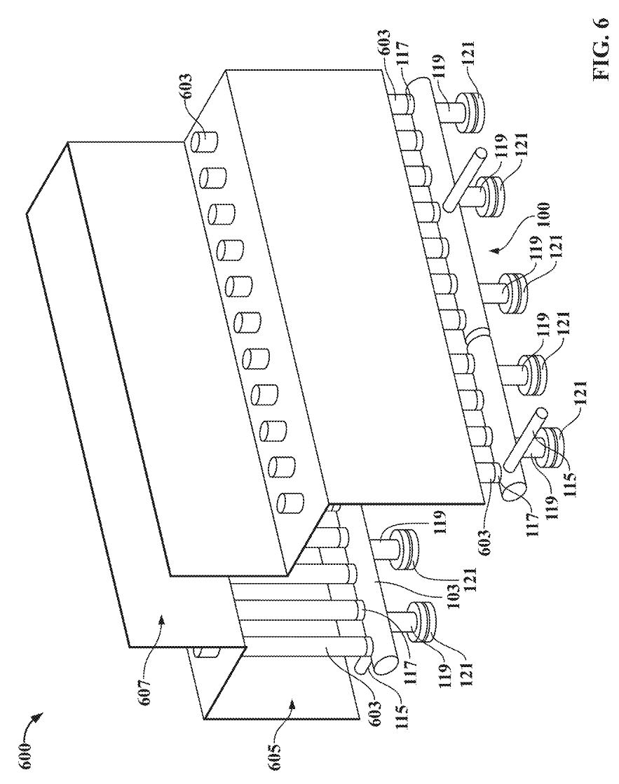

FIG. 6 depicts a partial cross-sectional perspective view of a portion of an illustrative steam cracker 600 configured to provide a hydrocarbon and steam mixture to a plurality of radiant tubes 603 disposed within the steam cracker 600 via a plurality of the manifolds 100 shown in FIGS. 1 and 2, according to one or more embodiments. The steam cracker 600 can include a radiant firebox 605 that can include the plurality of radiant tubes 603 disposed therein. The hydrocarbon and steam mixture can be introduced into the inlets 115 of the plurality of manifolds 100, distributed into a plurality of the radiant tubes 603 connected to the plurality of outlets 117 of each manifold 100, and can flow through the radiant tubes 603 to produce a steam cracker effluent. The steam cracker effluent can be recovered from the radiant firebox 605 at the ends of the radiant tubes 603 opposite the manifolds 100. A fuel can be combusted in the presence of an oxidant within the radiant firebox 605 via a plurality of burners (not shown for clarity) to produce heat and a flue gas. Heat produced via combustion of the fuel can be transferred to the radiant tubes 603 to drive the endothermic reaction to convert alkanes, e.g., ethane, to alkenes, e.g., ethylene. The flue gas can flow from the radiant firebox 605 into a convection section 607 of the steam cracker 600.

As shown in FIG. 6, in some embodiments, the plurality of manifolds 100 can be positioned beneath the radiant firebox 605 such that the hydrocarbon and steam mixture introduced into the radiant tubes 603 via the plurality of manifolds 100 can flow upwardly through the radiant firebox 605. In other embodiments, not shown, the plurality of manifolds 100 can be positioned above the radiant firebox 605 such that the hydrocarbon and steam mixture introduced into the radiant tubes 603 via the plurality of manifolds 100 can flow downwardly through the radiant firebox 605.

Steam crackers are well known in the art and need not be further described. Suitable steam crackers, product recovery configurations, other equipment, and process conditions can include those disclosed in U.S. Patent Nos.: 6,419,885; 7,560,019; 7,993,435; 8,105,479; 8,197,668; 8,882,991; 9,637,694; 9,777,227; 10,294,432; 11,286,435; 11,352,576; 11,591,529; U.S. Patent Application Publication Nos.: 2014/0061096; 2014/0357923; 2016/0376511; 2018/0170832; 2019/0016975; 2024/0166953; and WO Publication Nos.: WO 2018/111574; WO/2020/096972; WO/2020/096974; WO/2020/096977; and WO/2020/096979.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A manifold, comprising:
a conduit having a first end and a second end, wherein:
the first end of the conduit is sealed via a first end plate,
the second end of the conduit is sealed via a second end plate,
the conduit, the first end plate, and the second end plate define a cavity therein,
at least one inlet is disposed on the conduit between the first end and the second end thereof that is configured to convey a fluid into the cavity,
a plurality of outlets is disposed on the conduit between the first end and the second end thereof, each outlet configured to convey a portion of the fluid out of the cavity, and
a plurality of service ports is disposed on the conduit between the first end and the second end thereof, each service port configured to be sealed via a cover; and
a plurality of screens disposed within the cavity, wherein each screen in the plurality of screens is configured to be inserted into and removed from the cavity via passage through an unsealed service port in the plurality of service ports, and wherein each screen defines a plurality of openings between a first end and a second end thereof.

2. The manifold of claim 1, wherein the plurality of screens comprises a first end screen that abuts the first end plate, a second end screen that abuts the second end plate, and a plurality of intermediate screens that serially abut one another such that a first end of the plurality of intermediate screens abuts the first end screen and a second end of the plurality of intermediate screens abuts the second end screen.

3. The manifold of claim 2, wherein the first end screen, the second end screen, and each intermediate screen in the plurality of intermediate screens are formed from a metal plate that defines the plurality of openings therethrough.

4. The manifold of claim 3, wherein each opening in the plurality of openings defined by each metal plate has an average cross-sectional length in a range from 5 mm to 12 mm.

5. The manifold of claim 2, wherein the first end screen, the second end screen, and each intermediate screen in the plurality of intermediate screens are in the form of a wire mesh that defines the plurality of openings therethrough.

6. The manifold of claim 5, wherein each opening in the plurality of openings defined by the wire mesh has an average cross-sectional length in a range from 5 mm to 12 mm.

7. The manifold of claim 1, wherein each screen in the plurality of screens has a curved surface between the first end and the second end thereof.

8. The manifold of claim 7, wherein each screen in the plurality of screens is oriented within the cavity such that the curved surface between the first and second end thereof curves toward the at least one inlet.

9. The manifold of claim 1, wherein the first end of each screen in the plurality of screens is located within a slot formed on an inner surface of the conduit between the first and second end thereof and the second end of each screen in the plurality of screens is secured to a structural member that is secured to the inner surface of the conduit.

10. The manifold of claim 9, wherein each structural member defines a bore therethrough, and wherein the second end of each screen in the plurality of screens is secured to the structural member via a pin, a screw, a bolt and a nut, a wire, or a combination thereof.

11. The manifold of claim 9, wherein each structural member defines a bore therethrough, and wherein the second end of each screen in the plurality of screens is secured to the structural member via a cotter pin.

12. The manifold according to claim 1, wherein the manifold comprises a single inlet disposed on the conduit between the first and second ends thereof.

13. The manifold of claim 12, wherein the inlet is centrally located between the first and second ends of the conduit.

14. The manifold of claim 1, wherein the outlets in the plurality of outlets are aligned with one another along a length of the conduit.

15. The manifold of claim 1, wherein the access ports in the plurality of access ports are aligned with one another along a length of the conduit.

16. The manifold of claim 15, wherein the plurality of outlets and the plurality of access ports are disposed on opposite sides of the conduit with respect to one another.

17. The manifold of claim 16, wherein a central longitudinal axis of the inlet is oriented at an angle in a range from 85 degrees to 95 degrees with respect a central longitudinal axis of each of the access ports in the plurality of access ports and a central longitudinal axis of each of the outlets in the plurality of outlets.

18. The manifold of claim 1, wherein:
the conduit and the first and second end plates are each formed from metal, and
the first and second end plates are welded to the first and second ends of the conduit, respectively.

19. The manifold of claim 1, wherein each service port in the plurality of service ports is configured to be sealed by securing a plate flange or a plug flange thereto via a plurality of removable fasteners.

20. A steam cracker furnace, comprising:
a radiant firebox comprising a plurality of radiant tubes disposed therein; and
at least one manifold, comprising:
a conduit having a first end and a second end, wherein:
the first end of the conduit is sealed via a first end plate,
the second end of the conduit is sealed via a second end plate,
the conduit, the first end plate, and the second end plate define a cavity therein,
at least one inlet is disposed on the conduit between the first end and the second end thereof that is configured to convey a hydrocarbon and steam mixture into the cavity,
a plurality of outlets is disposed on the conduit between the first end and the second end thereof,
each outlet in the plurality of outlets is configured to convey a portion of the hydrocarbon and steam mixture out of the cavity and into a corresponding radiant tube in the plurality of radiant tubes, and
a plurality of service ports is disposed on the conduit between the first end and the second end thereof, each service port configured to be sealed via a cover; and
a plurality of screens disposed within the cavity, wherein each screen in the plurality of screens is configured to be inserted into and removed from the cavity via passage through an unsealed service port in the plurality of service ports, and wherein each screen defines a plurality of openings between a first end and a second end thereof.

21. The steam cracker furnace of claim 20, wherein the manifold is positioned beneath the radiant firebox such that the portion of the hydrocarbon and steam mixture conveyed into the corresponding radiant tube flows upwardly through the radiant firebox.

22. The steam cracker furnace of claim 20, wherein the manifold is positioned above the radiant firebox such that the portion of the hydrocarbon and steam mixture conveyed into the corresponding radiant tube flows downwardly through the radiant firebox.

23. The steam cracker furnace of claim 20, wherein:
the steam cracker furnace comprises at least a first manifold, a second manifold, and a third manifold,
the first, second, and third manifolds are serially aligned along a longitudinal axis of the radiant firebox, and
a distance between the first manifold and the second manifold is substantially the same as a distance between the second manifold and the third manifold.

24. A steam cracking process using the steam cracker of claim 20, comprising:
combusting a fuel within the radiant firebox to produce heat and a flue gas;
introducing a hydrocarbon and steam mixture into at least one inlet disposed on the conduit;
conveying a portion of the hydrocarbon and steam mixture into each outlet disposed on the conduit and into the corresponding radiant tube located within the radiant firebox to produce a steam cracker effluent.
